(19) United States
(12) Patent Application Publication
(10) Pub. No.: US 2010/0017470 A1
(43) Pub. Date: Jan. 21, 2010

(54) APPARATUS AND METHODS FOR COMMUNICATION USING ICON

(75) Inventors: Yong-Joon Hyoung, Gyeonggi-do (KR); Jin-Young Shin, Seoul (KR); Kwang-Yong Choi, Gyeonggi-do (KR)

Correspondence Address: CANTOR COLBURN, LLP, 20 Church Street, 22nd Floor, Hartford, CT, 06103, US

(73) Assignee: E-INFRA NETWORKS, Seoul (KR)

(21) Appl. No.: 11/908,172

(22) PCT Filed: Mar. 7, 2006
(86) PCT No.: PCT/KR2006/000793

§ 371 Date: Sep. 3, 2009

(30) Foreign Application Priority Data
Mar. 9, 2005 (KR) 10-2005-0019747

(51) Int. Cl. G06F 3/048; G06F 15/16

(52) U.S. Cl. 709/204; 715/811

(57) ABSTRACT

Disclosed are an apparatus and method for communication using an icon. A first communication terminal of a first user stores a second user icon profile including an icon(s) representing at least one communication terminal used by a second user and a second communication terminal of the second user stores a first user icon profile including an icon(s) representing at least one communication terminal used by the first user. When the first user a first icon from the at least one icon forming the second user icon profile, the first user can communication with the second communication terminal of the second user represented by the first icon using the first communication terminal.

### TECHNICAL FIELD

The present invention relates to an apparatus and method for communication using a communication terminal, more particularly, to an apparatus and method for communication by exchanging icon profiles between users and using icons forming the exchanged icon profiles, and a recording medium for recording a program which is executed in a computer.

### BACKGROUND ART

When a person named A changes works or positions, A's office phone number may be changed. If A changes works and A's office phone number is changed, a person who wishes to call A cannot reach A until he/she learns A's new office phone number. Also, A's office phone number stored in an address book of a mobile phone is not automatically changed. Therefore, A may not receive a call which is important to A.

Further, when A's mobile phone number, office phone number, home phone number, e-mail address, mini homepage address and the like stored in an address book (or list) of a mobile phone are changed, the changed information is not automatically changed or updated in the address book of the mobile phone.

In addition, when a phone call is made to a third party or a phone call is received from a third party, there is no way to get information of the third party who received the phone call or relationship with the third party.

### DISCLOSURE OF INVENTION

### Technical Problem

An aspect of the present invention provides an apparatus and method for automatically updating a communication terminal number of a user in address books of communication terminals of persons who form the social network with the user when the communication terminal number of the user is changed.

Another aspect of the present invention provides a method for confirming information of relation between me or my acquaintance and a person when a phone call is made to the person or a phone call is received from the person.

### Technical Solution

According to an aspect of the present invention, there is provided a communication terminal comprising: an icon profile storage means for storing a plurality of icon profiles of a first user; a selection means for selecting a desired icon profile among the plurality of icon profiles stored in the icon profile storage means; a transmission means for transmitting the icon profile selected by the selection means to the outside of the communication terminal; a receiving means for receiving an icon profile of a second user input from the outside of the communication terminal; and a received icon profile storage means for storing the icon profile of the second user received through the receiving means, in which the plurality of icon profiles of the first user each include icons for representing information of at least one communication terminal used by the first user and the icon profile of the second user includes icons for representing information of the communication terminal used by the second user. The information of the communication terminal includes information whether the communication terminal is in the communicable status at present.

According to another aspect of the present invention, there is provided a method for communication using an icon comprising: an icon profile generating step, in which a first user and a second user separately generate their own icon profiles using their own communication terminals; an icon profile exchanging step, in which the first user and the second user exchange their selected icon profiles using their own communication terminals; and a communication channel forming step, in which when the first user selects a first icon from at least one icon forming the icon profile of the second user displayed on the communication terminal of the first user, the communication terminal of the first user forms a communication channel to perform communication with the communication terminal of the second user represented by the selected first icon. Here, the icon profile of the first user and the icon profile of the second user each include icons for representing information of at least one communication terminal used by the first user and the second user.

According to still another aspect of the present invention, there is provided a method for communication using an icon comprising: a first icon profile selecting step, in which a first user selects a first icon profile from a plurality of first user icon profiles stored in an icon profile storage means using a first communication terminal of the first user; a transmitting step, in which the first communication terminal transmits the selected first icon profile to a communication terminal of a second user; and a receiving and storing step, in which the first communication terminal receives and stores an icon profile of the second user input from the communication terminal of the second user in response to the first user icon profile, in which the plurality of first user icon profiles include icons for representing information of at least one communication terminal used by the first user and the icon profile of the second user includes icons for representing information of the communication terminal used by the second user.

The method further comprises a communication channel forming step, in which when the first user selects a first icon from at least one icon forming the icon profile of the second user displayed on the first communication terminal, the first communication terminal forms a communication channel to perform communication with a communication terminal of the second user represented by the selected first icon.

The method further comprises a changed information receiving step, in which when the second user changes information of a communication terminal of the second user represented by a first icon selected from at least one icon forming the icon profile of the second user displayed on the first communication terminal using a communication terminal of the second user, the first communication terminal receives the changed information of a communication terminal of the second user input from the communication terminal of the second user; and a communication channel forming step, in which when the first user selects the first icon displayed on the first communication terminal, the first communication terminal forms a communication channel to perform communication with the changed communication terminal of the second user represented by the selected first icon.

A computer-readable recording media storing a program may record the above-described method.

According to yet another aspect of the present invention, there is provided a method for searching information of consanguinity degree comprising: a first icon selecting step, in which a first user selects a first icon representing information of consanguinity degree from an icon profile of a second user (Jinny) displayed on a first communication terminal of the first user;

an information reading step, in which the first communication terminal reads information of at least one third user (Chris) forming the social network with the second user from a server; and a displaying step, in which the first communication terminal displays an icon profile of the at least one third user (Chris) on the first communication terminal, based on the information of the at least one third user read from the server, in which the icon profile of the second user includes the first icon representing the name of the second user and the degree of consanguinity between the first user and the second user.

According to a further aspect of the present invention, there is provided a method for searching information of consanguinity degree, in which when a first user inquires of a server about a degree of consanguinity with a second user while the first user makes a phone call to the second user, the server transmits the degree of consanguinity between the first user and the second user to a communication terminal of the first user.

According to a further aspect of the present invention, there is provided a method for searching information of consanguinity degree, in which when a first user inquires of a server about a degree of consanguinity with a second user who has made a phone call to the first user, the server transmits the degree of consanguinity between the first user and the second user to a communication terminal of the first user.

Additional and/or other aspects and advantages of the present invention will be set forth in part in the description which follows and, in part, will be obvious from the description, or may be learned by practice of the invention.

### ADVANTAGEOUS EFFECTS

As described above, since the communication terminal according to the present invention shows an icon representing a name and an available communication terminal of a correspondent in an address book, a killer app, the communication terminal user can communication with the communication terminal of the correspondent represented by the icon during available hours of the correspondent.

Since the icon shows whether the correspondent communication terminal is communicable or not, the communication terminal according to the present invention can communicate with the correspondent when available.

Since the communication terminal according to the present invention shows information of consanguinity degree between a first user and a second user who sends an icon profile, the first user may not receive a phone call not desired. Therefore, the first user can intercept spam calls.

Also, by the method for searching and confirming information of consanguinity degree, a first user can readily know the social relationship with a second user (for example, degree of consanguinity), or the social relationship between a person(s) forming the social network with the first user and a second before the first user makes a phone call to the second user.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 shows a block diagram of a system according to an embodiment of the present invention which can exchange an icon profile and communicate using an icon in the icon profile;

FIG. 2 shows a block diagram of a system according to another embodiment of the present invention which can exchange an icon profile and communicate using an icon in the icon profile;

FIG. 3 shows a block diagram of a communication terminal according to an embodiment of the present invention which can exchange an icon profile and communicate using an icon in the icon profile;

FIG. 4 shows an icon list stored in an icon storage means of the communication terminal;

FIG. 5 shows a first embodiment of the first user icon profile;

FIG. 6 is a diagram showing the method for inputting a number of a communication terminal or an address represented by icons of the first user icon profile shown in FIG. 5;

FIG. 7 shows a second embodiment of the first user icon profile;

FIG. 8 shows an icon profile list including a plurality of icon profiles displayed in the communication terminal;

FIG. 9 shows an example of the graphic user interface to send the selected icon profile to the correspondent communication terminal.

FIG. 10 shows an example of the graphic user interface to confirm the icon profile to be sent to a communication terminal of the other party;

FIG. 11 shows an example of the delivery report graphic user interface displayed on a communication terminal of a receiver who receives the icon profile;

FIG. 12 shows an example of the graphic user interface to confirm the icon profile to be delivered on a communication terminal of the receiver;

FIG. 13 shows an example of the graphic user interface of the second user profile list showing a list 1200 of a plurality of icon profiles made by the second user;

FIG. 14 shows an example of the icon profile list (or contact list) stored in the first communication terminal;

FIG. 15 is a schematic diagram showing the method for confirming the social network of the person selected in the icon profile list using the first communication terminal.

FIG. 16 shows an example of the graphic user interface when the first user selects the e-mail icon of the second user, shown in FIG. 14, while the e-mail address of the second user is set to be not open to the public by the second user;

FIG. 17 shows an example of the graphic user interface when the first user selects the e-mail icon of the second user, shown in FIG. 14, while the e-mail address of the second user is set to be open to the public by the second user;

FIG. 18 shows an example of the graphic user interface when the first user selects the mobile phone icon of the second user, shown in FIG. 14, while the mobile phone number of the second user is set to be not open to the public by the second user;

FIG. 19 shows an example of the graphic user interface when the first user selects the mobile phone icon of the second user, shown in FIG. 14, while the mobile phone number of the second user is set to be open to the public by the second user;

FIG. 20 to FIG. 23 show examples of the graphic user interface of a mini-homepage of the second user displayed in the communication terminal of the first user when the first user selects the mini-homepage icon of the second user shown in FIG. 14;

FIG. 24 is a flow chart showing the method for communication between the first user and the second user using icons according to an embodiment of the present invention; and

FIG. 25 is a flow chart showing the method for synchronizing the corrected office phone number of the second user with communication terminals of individuals forming the network with the second user according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

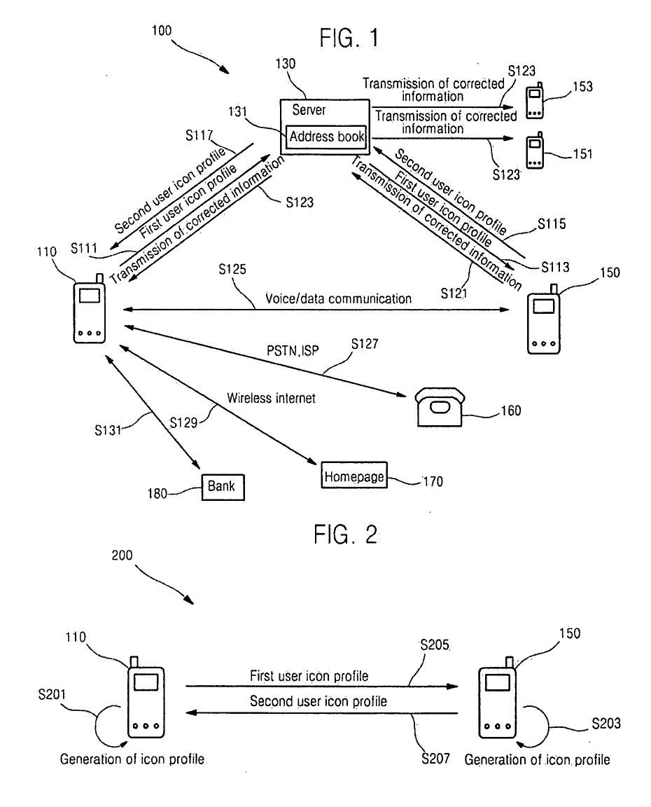

FIG. 1 shows a block diagram of a system according to an embodiment of the present invention which can exchange an icon profile and communicate using an icon in the icon profile. Referring to FIG. 1, the system 100 according to the present invention comprises at least two communication terminals 110, 150, 151, 153, 160, 170 and 180 and a server 130.

The application (also called “client program”) can be downloaded from the server 130, distributed as an independent installation program stored in a CD or disk, or transmitted through an web page or by FTP for installation. Also, the application or client program can be embedded in a communication terminal (for example, mobile phone, PDA etc.) for use.

The communication terminal includes a communication apparatus using Code Division Multiple Access (CDMA) (for example, mobile phone, PDA, etc.), a communication means using Global System for Mobile Communications (GSM) (for example, mobile phone, PDA, etc.), a communication means using Time Division Multiple Access TDMA (for example, mobile phone, PDA, etc.), a communication apparatus using Public Switched Telephone Network (PSTN) (for example, wired telephone for home use, wired telephone for office use, etc.), a communication means using Internet Service Provider (ISP) (for example, PC etc.).

The communication terminal (for example, mobile phone) 110 of a first user transmits a first user icon profile selected by the first user from at least one icon profile stored in its memory to the server 130 and/or a relay system (not shown) of a mobile communication company through a wired/wireless communication network, which is then transmitted to the communication terminal 150 of a second user (for example, mobile phone) (S111).

The at least one icon profile includes at least one icon 411 to 420, as shown in FIG. 4, in which the icons 411 to 420 represent numbers of communication terminals (for example, mobile phone number, office phone number, home phone number, etc.) or addresses (for example, e-mail address, mini-homepage address, etc.). The icon is a small image for representing an application program, a function, a certain idea or an object having a special meaning in a graphic user interface (GUI) of a computer.

Here, the mobile phone 110 of the first user also transmits basic information of the first user (for example, mobile phone number of the first user), the first user icon profile and basic information of the second user (for example, mobile phone number of the second user) to the server 130 and/or the relay system (not shown) of the mobile communication company through a wired/wireless communication network (S111).

The server 130 and/or the relay system (not shown) of the mobile communication company stores at least one of the basic information of the first user, the basic information of the second user and the first user icon profile in an address book database 131 and transmits the first user icon profile to the mobile phone 150 of the second user through the wired/wireless communication network, based on the basic information of the second user (for example, mobile phone number of the second user) (S113). If the first user has been admitted to be a member of the server 130 through predetermined formalities, the basic information of the first user includes an ID of the first user as a member and a password.

The second user mobile phone 150 which has received the first user icon profile transmits a second user icon profile set to be default by the second user or a second user icon profile selected by the second user from the second user icon profile to the server 130 through the wired/wireless communication network, which is then transmitted to the mobile phone 110 of the first user (S115). Here, the mobile phone 150 of the second user also transmits the basic information of the first user (for example, mobile phone number of the first user), the second user icon profile and the basic information of the second user (for example, mobile phone number of the second user) to the server 130 through the wired/wireless communication network (S115).

The server 130 stores at least one of the basic information of the first user, the basic information of the second user and the second user icon profile in the address book database 131 and transmits the second user icon profile to the mobile phone 110 of the first user through the wired/wireless communication network, based on the basic information of the first user (for example, mobile phone number of the first user) (S117).

If the second user has been admitted to be a member of the server 130 through predetermined formalities, the basic information of the second user includes an ID of the second user as a member and a password. The mobile phone 110 of the first user receives and stores the second user icon profile input through the server 130 or the relay system of the mobile communication company.

When the first user selects (or presses) an icon representing a mobile number 1320 of the second user displayed in a screen 1300 of the mobile phone 110 of the first user, as shown in FIG. 14, the mobile phone 110 of the first user makes a call to the mobile phone 150 of the second user, as shown in FIG. 18 or FIG. 19 (S125).

Also, when the first user selects (or presses) an icon representing an office phone number 1330 of the second user displayed in the screen 1300 of the mobile phone 110 of the first user, as shown in FIG. 14, the mobile phone 110 of the first user makes a call to the office phone 150 of the second user through the PSTN communication network (S127).

Further, when the first user selects (or presses) an icon representing a mini homepage address 1340 of the second user displayed in the screen 1300 of the mobile phone 110 of the first user, as shown in FIG. 14, the mobile phone 110 of the first user is connected to the mini homepage of the second user through the wired/wireless communication network (S129). In addition, the second user may select an icon representing financial information to transfer money to a bank 180 through the wired/wireless communication network (S131).

The server 130 and/or the relay system (not shown) of the mobile communication company stores information of all the individuals forming the network with the first user, including, for example, information of the second user, and information of all the individuals forming the network with the second user, including, for example, information of the first user. Therefore, when the second user corrects information of his/her communication terminal (for example, office phone number of the second user) through his/her mobile phone 150 or PC (not shown) connected to the server 130 without changing an icon representing the office phone number, the mobile phone 150 of the second user or PC transmits the corrected office phone number of the second user to the server 130 and/or the relay system (not shown) of the mobile communication company (S121).

The server 130 and/or the relay system (not shown) of the mobile communication company stores the changed office phone number of the second user in the address book database 131 and transmits the changed office phone number of the second user to the communication terminals 110, 151 and 153 of individuals forming the network with the second user, based on the information of individuals forming the network with the second user (for example, mobile phone number) (S123).

Here, the first user selects and presses the icon representing the office phone number 1330 of the second user displayed in the screen 1300 of the mobile phone 110 of the first user, as shown in FIG. 14, the mobile phone 110 of the first user makes a call to the office phone 150 of the second user through the PSTN communication network (S127).

Thus, since the changed communication terminal information of the second user is updated immediately to the server 130, the relay system of a mobile communication company and at least one communication terminal of each individual forming the network with the second user, the individuals forming the network with the second user can communicate with the second user through an icon representing the communication terminal which the second user approves.

FIG. 2 shows a block diagram of a system according to another embodiment of the present invention which can exchange an icon profile and communicate using an icon in the icon profile. For example, the system 200 of FIG. 2 shows the infrared communication between terminals 110 and 150.

Referring to FIG. 2, a first user and a second user each create at least one icon profile using their own communication terminals 110 and 150 (S201 and S203) and exchange a first user icon profile and a second user profile stored in their own communication terminals 110 and 150 through a wireless communication network (S205 and S207).

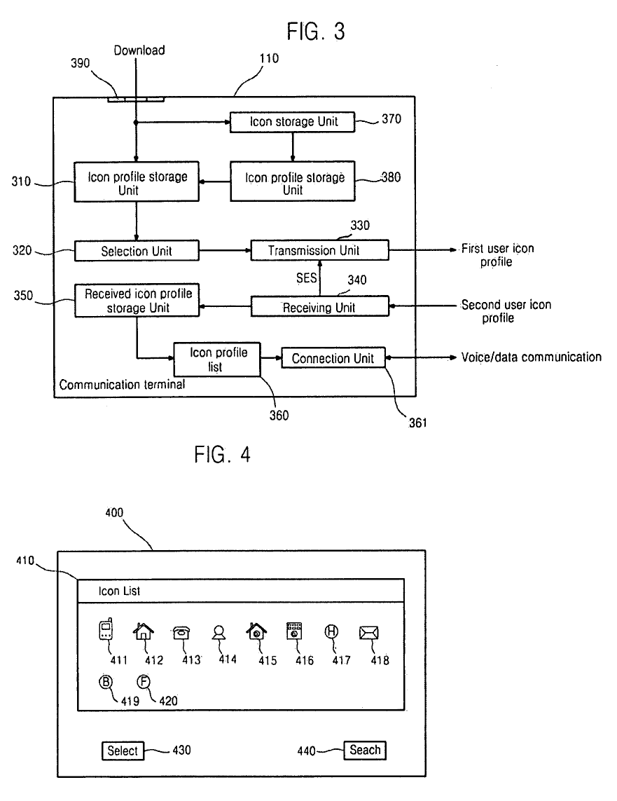

FIG. 3 shows a block diagram of a communication terminal according to an embodiment of the present invention which can exchange an icon profile and communicate using an icon in the icon profile.

Referring to FIG. 3, the communication terminal 110 comprises an icon profile storage means 310, a selection means 320, a transmission means 330, a receiving means 340, a received icon profile storage means 350, an icon profile list (or contact list) 360 and a connection means 361. Also, the communication terminal 110 further comprises an icon storage means 370, an icon profile generating means 380 and a connector 390.

Each means 310 to 390 represents a predetermined module, which indicates an independent software and/or hardware unit. The means 310 to 390 may be performed by an independent button or program.

The communication terminals 110, 150, 151 and 153 shown in FIG. 1 have substantially the same structure of the communication terminal 110 shown in FIG. 3.

The icon profile storage means 310 receives at least one icon profile generated by the icon profile generating means 380 or at least one icon profile of the first user input through the connector 390 and stores the received icon profile(s).

The first user icon profile(s) may be made by the icon profile generating means 380 in the first user communication terminal 110 and/or an icon profile generating means (not shown) outside the first user communication terminal 110. The icon profile generating means (not shown) outside the first user communication terminal 110 may be a PC.

The selection means 320 selects a first user icon profile to be transmitted from at least one first user icon profile stored in the icon profile storage means 310. The transmission means 330 transmits the first user icon profile selected by the selection means 320 to the second user communication terminal 150. The receiving means 340 receives the icon profile of the second user input from the communication terminal 150 of the second user. The received icon profile storage means 350 stores the icon profile of the second user received through the receiving means 340. The received icon profile storage means 350 stores various icon profiles transmitted from various individuals.

The icon profile list 360 displays names of persons who transmit icon profiles and icons representing communication means which the persons approve in a predetermined order, as shown in FIG. 14.

When an icon (for example, an icon representing mobile phone number, an icon representing office phone number, an icon representing e-mail), which is allowed for an individual (Jinny) selected through the icon profile list means 360, is selected, as shown in FIG. 14, the connection means 361 performs communication such as voice and letters with an individual communication means which the selected icon represents as shown in FIG. 1.

FIG. 4 shows the icon list stored in the icon storage means. Referring to FIG. 3 and FIG. 4, the icon storage means 370 stores at least one icon. The at least one icon includes an icon representing a mobile number 411, an icon representing a home phone number 412, an icon representing an office phone number 413, an icon representing a messenger address 414, an icon representing a home address 415, an icon representing an office address 416, an icon representing a mini homepage address 417, an icon representing an e-mail address 418, an icon representing a bank account number 419 and an icon representing a fax number 420.

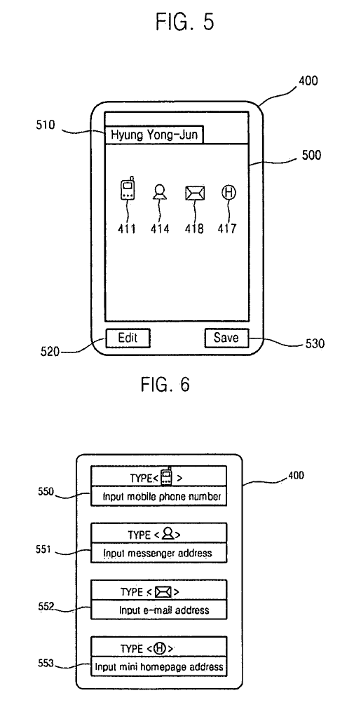

FIG. 5 shows a first embodiment of the first user icon profile. When “Hyung Yong-Jun” as the first user presses an edit button 520 of his mobile phone 110, the icon list 410 shown in FIG. 4 is displayed on the screen of the mobile phone 110 of the first user.

The “Hyung Yong-Jun” forms an icon profile 500 including the icon representing a mobile number 411, the icon representing a messenger address 414, the icon representing an e-mail address 418 and the icon representing a mini homepage address 417 using a select button 430 and a detect button 440. The “Hyung Yong-Jun” stores the formed icon profile 500 in a memory of the mobile phone 110 using a save button 530. The “Hyung Yong-Jun” can correct/change the formed icon profile 500 and even the name “Hyung Yong-Jun 510” using the edit button 520.

FIG. 6 is a diagram showing the method for inputting the number of a communication terminal or addresses represented by icons of the first user icon profile shown in FIG. 5. “Hyung Yong-Jun” can input a mobile phone number in a predetermined frame 550, a messenger address in a predetermined frame 551, an e-mail address in a predetermined frame 552 and a mini homepage address in a predetermined frame 553 using the edit button 520.

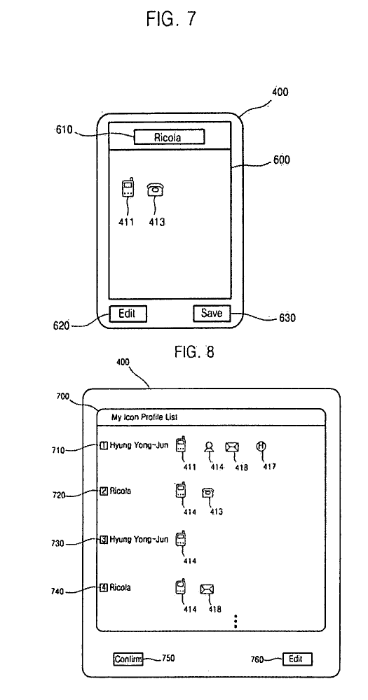

FIG. 7 shows a second embodiment of the first user icon profile. When “Hyung Yong-Jun” as the first user presses an edit button 620, the icon list 410 shown in FIG. 4 is displayed on the screen of the mobile phone 110 of the first user.

The “Hyung Yong-Jun” forms an icon profile 600 including the icon representing a mobile number 411 and the icon representing an office phone number 413 using the select button 430 and the detect button 440. The formed icon profile 600 is stored in a memory of the mobile phone 110. The formed icon profile 600 may be corrected/changed by the edit button 620 and even the name “Hyung Yong-Jun” can be changed into “Ricola 610”.

By the same method explained with reference to FIG. 4 to FIG. 7, the first user can form a plurality of icon profiles and each of the plurality of icon profiles includes at least one icon 411 to 420 as shown in FIG. 4.

FIG. 8 shows an icon profile list including a plurality of icon profiles displayed in the communication terminal. Referring to FIG. 8, the icon profile list 700 shows a plurality of first user icon profiles 710, 720, 730 and 740.

The first user can select a first user icon profile to be transmitted to the communication terminal 150 of the second user from the plurality of first user icon profiles 710, 720, 730 and 740 using a confirm button 750. Also, the first user can correct/change the first user icon profiles 710 to 740 which have been already formed, as explained with reference to FIG. 4 to FIG. 7, using an edit button 760.

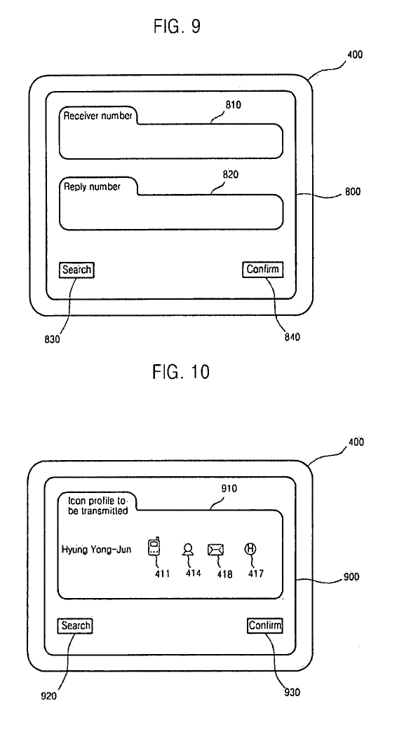

If the first user selects the icon profile 710 and presses the confirm button 750, a graphic user interface 800 is displayed on the screen 400 of the mobile phone 110, as shown in FIG. 9.

The first user inputs the mobile phone number of the second user, to which the selected icon profile 710 is transmitted, into a receiver number input frame 810 and inputs a mobile phone number, to which the reply icon profile is transmitted from the communication terminal 150 of the second user, into a reply phone number input frame 820. When the first user presses a confirm button 840, the icon profile 710 is transmitted to the mobile phone 150 of the second user through the server 130 and/or the relay system (not shown) of the mobile communication company.

Also, the first user may select an icon profile to be transmitted to the mobile phone 150 of the second user from the icon profile list 700 shown in FIG. 8 using a detect button 830.

FIG. 10 shows an example of the graphic user interface to confirm the icon profile to be sent to a communication terminal of the other party. Referring to FIG. 9 and FIG. 10, when the first user presses the confirm button 840, the icon profile (910=710) is displayed on the screen 400 of the mobile phone 110 of the first user. When the first user presses the confirm button 930, the selected icon profile 710 is transmitted to the mobile phone 150 of the second user through the server 130 and/or the relay system (not shown) of the mobile communication company.

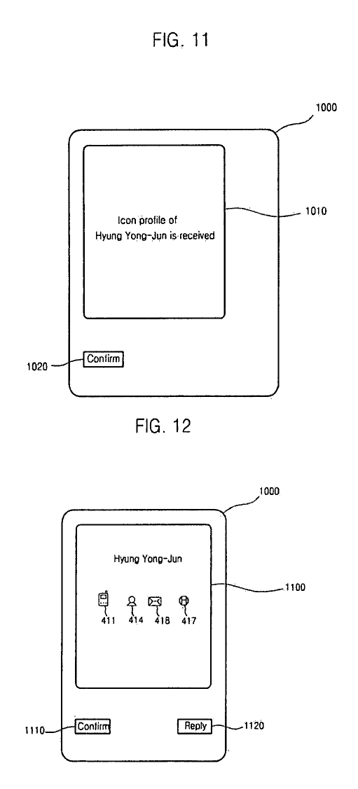

Also, the first user may repeatedly select the icon profile to be transmitted to the mobile phone 150 of the second user from the icon profile list 700 shown in FIG. 8 using the detect button 920. FIG. 11 shows an example of the receipt report graphic user interface displayed on a communication terminal of a receiver who receives the icon profile. FIG. 12 shows an example of the graphic user interface to confirm the received icon profile on the communication terminal of the receiver.

Referring to FIG. 1, FIG. 2 and FIG. 12, when the first user icon profile 1100 is transmitted to the second user mobile phone 150, a frame 1010 to display that which icon profile is transmitted from whom is activated on the screen 1000 of the second user mobile phone 150. When the second user presses the confirm button 1020, the first user icon profile 1100 transmitted from the first user mobile phone 110 is displayed on the screen 1000 of the second user mobile phone 150, as shown in FIG. 12.

Here, when the second user presses the confirm button 1110, the second user icon profile set to be default is transmitted to the mobile phone 110 of the first user through the server 130 and/or the relay system (not shown) of the mobile communication company.

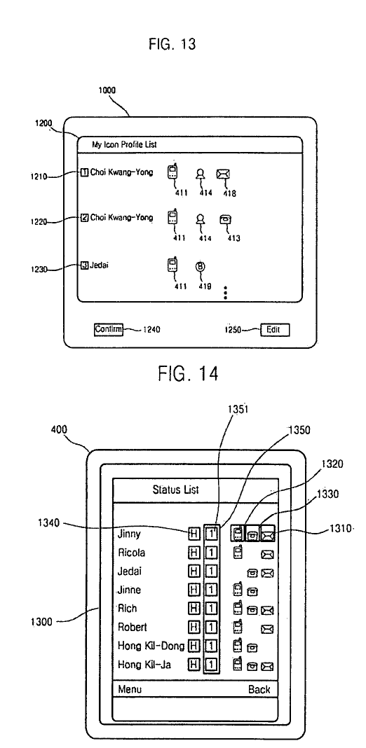

However, when the second user presses the reply button 1120, the second user icon profile list 1200 is displayed on the screen 1000 of the mobile phone 150, as shown in FIG. 13. FIG. 13 shows an example of the graphic user interface of the second user profile list showing the list 1200 of a plurality of icon profiles formed by the second user.

The icon profiles 1210, 1220 and 1230 of the second user shown in the second user profile list 1200 are created by the same method explained for generating the first user icon profile with reference to FIG. 3 to FIG. 7. The icon profile 1210 of “Choi Kwang-Yong” as the second user includes the icon representing a mobile number 411, the icon representing a messenger address 414 and the icon representing an e-mail address 418.

Also, icon profile 1230 of Jedai, ID name of “Choi Kwang-Yong” as the second user, includes the icon representing a mobile number 411 and an icon representing bank account number 419. When the second user selects a second user icon profile (for example, 1210) to be transmitted to the mobile phone 110 of the first user and presses a confirm button 1240, the selected second user icon profile is transmitted to the mobile phone 110 of the first user through the server 130 and/or the relay system (not shown) of the mobile communication company.

FIG. 14 shows an example of the icon profile list (or contact list) stored in the first communication terminal. Referring to FIG. 14, the contact list includes icon profiles of a plurality of second users. For example, the icon profile of “Jinny” includes an icon representing an e-mail address 1310, an icon representing a mobile number 1320, an icon representing an office phone number 1330, an icon representing a mini homepage address 1340 and an icon representing a degree of consanguinity 1351. The number shown by the reference number 1350 represents the degree of consanguinity between the first user and the respective second users (Jinny, Ricola, Jedai, Jinne, Rich, Robert, Hong Kil-Dong and Hong Kil-Ja).

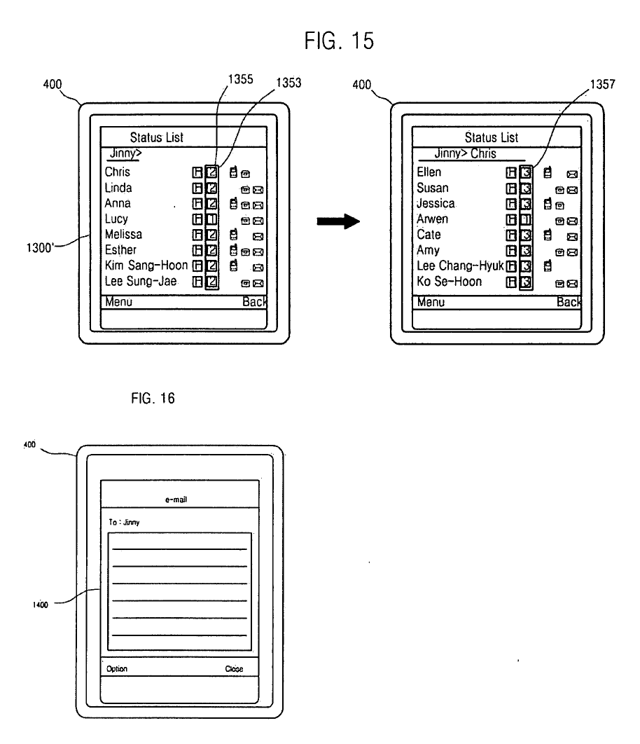

Referring to FIG. 1, FIG. 14 and FIG. 15, the method for describing the information of consanguinity degree on the screen 400 of the communication terminal 110 of the first user is explained as follows. The first user selects a first information of consanguinity degree icon 1351 from the icon profile of a second user (for example. Jinny) shown on the first communication terminal 110. The first communication terminal 110 reads information of at least one third user (for example, Chris, Linda, Anna, Lucy, Melissa, Esther, Kim Sang-Hoon, Lee Sung-Jae) forming the social network with the selected second user (for example, Jinny), as shown in FIG. 15, from the server 130 through the mobile communication network.

The first communication terminal 110 displays a contact list 1300′ including the icon profile of the at least one third user on the screen of the first communication terminal 110, as shown in FIG. 15, based on the information of the at least one third user (for example, Chris, Linda, Anna, Lucy, Melissa, Esther, Kim Sang-Hoon, Lee Sung-Jae) read from the server 130.

The icon profile of the second user (for example, the icon profile of Jinny) includes the name (Jinny) of the second user and the first information of consanguinity degree icon 1351 representing the degree of consanguinity between the first user and the second user.

The icon profile of the third user (for example, the icon profile of Chris) includes the name (Chris) of the third user and a second information of consanguinity degree icon 1355 representing the degree of consanguinity between the first user and the third user. In another embodiment, the icon profile of the third user (for example, the icon profile of Chris) may include the name (Chris) of the third user and the second information of consanguinity degree icon 1355 representing the degree of consanguinity between the second user (for example, Jinny) and the third user (Chris).

The reference number 1353 represents the degree of consanguinity between the third user (Chris, Linda, Anna, Melissa, Esther, Kim Sang-Hoon, Lee Sung-Jae) who are in the first degree of consanguinity with Jinny and the first user. Lucy is in the first degree of consanguinity with the first user while being in the first degree of consanguinity with the second user (Jinny). Here, the first degree of consanguinity means an acquaintance of the first user and the second degree of consanguinity means an acquaintance of the acquaintance of the first user.

If the first user selects the information of consanguinity degree icon 1355 of Chris who is in the first degree of consanguinity with Jinny, the second user, the mobile phone 110 of the first user reads information of fourth users (Ellen, Susan, Jessica, Arwen, Cate, Amy, Lee Chang-Hyuk, Ko Se-Hoon) forming the social network with Chris from the server 130.

The mobile phone 110 of the first user displays the icon profiles of the fourth users, based on the information of the fourth user, on the contact list. The number shown by the reference number 1357 represents the degree of consanguinity between the first user and the fourth users (Ellen, Susan, Jessica, Arwen, Cate, Amy, Lee Chang-Hyuk, Ko Se-Hoon). Also, Ellen is in the first degree of consanguinity with Chris who is in the first degree of consanguinity with Jinny.

Now, the method for confirming a degree of consanguinity using another communication terminal according to the present invention with reference to FIG. 1 is describes as follows. The first user selects the phone number of a second user who is on the communication list of the communication terminal 110 of the first user and has made a call to the communication terminal 110.

The communication terminal 110 transmits a signal to obtain social network information of the selected second user to the server 130 which stores information of individual(s) forming a network with the first user and/or information of individual(s) forming a network with the second user.

The communication terminal 110 displays the degree of consanguinity between the first user and the second user and/or information of consanguinity degree between the individuals forming the network with the first user and the second user on the communication terminal 110, based on the social network information of the second user transmitted from the server 130 in response to the signal. Also, the method for confirming a degree of consanguinity using the communication terminal storing information of the social network of at least one third user in the address book according to the present invention is described as follows.

The first user selects the second user who is shown in the communication list of his/her communication terminal 110 and has made a call to the communication terminal 110. The communication terminal 110 transmits a signal to obtain social network information of the selected second user to the server 130 which stores information of the social network of the first to third users.

The communication terminal 110 displays at least one of the degree of consanguinity between the first user and the second user and the degree of consanguinity between the second user and the third user on the communication terminal 110, based on the social network information of the first to third users transmitted from the server 130 in response to the signal.

By the same method as described above, the first user can inquire of the server 130 about the degree of consanguinity of the second user to who the first user wishes to make a call. Also, the first user can inquire of the server 130 about the degree of consanguinity between the second user to who the first user wishes to make a call and a third user stored in his/her address book.

Thus, since the address book database 131 of the server 130 stores information of individuals forming the social network with the first user, information of individuals forming the social network with the second user and information of individuals forming the social network with the third user, it is possible to know the consanguinity relation between a person who has made a call or a person who will make a call and the first user, the second user or the third user.

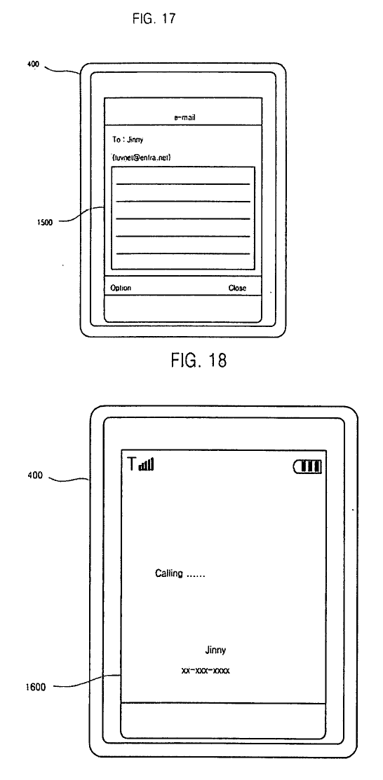

FIG. 16 shows an example of the graphic user interface when the first user selects the e-mail icon of the second user, shown in FIG. 14, while the e-mail address of the second user is set to be not open to the public by the second user. FIG. 17 shows an example of the graphic user interface when the first user selects the e-mail icon of the second user, shown in FIG. 14, while the e-mail address of the second user is set to be open to the public by the second user.

Referring to FIG. 14 to FIG. 17, when the first user selects the icon representing an e-mail address 1310 of “Jinny” displayed on the screen 400 of the mobile phone 110, frames 1400 and 1500 to send an e-mail are displayed on the screen 400. Unlike the frame 1400 shown in FIG. 16, the frame 1500 shown in FIG. 17 displays the e-mail address of “Jinny”. “Jinny”, the second user, may decide whether the e-mail address is to be open or not by using her mobile phone. The first user can write e-mail using the mobile phone 110 and transmit the e-mail to the mobile phone 150 or a predetermined PC of “Jinny”, the second user, using predetermined functions of the “option”.

The second user can set icons of the icon profile shown in FIG. 14 to represent the present status of the communication terminal of the second user, for example, whether the mobile phone of the second user is busy, whether the second user is absent or whether the mobile phone of the second user is roamed abroad since the second user has gone abroad. Therefore, the first user can know the status of the communication terminal of the second user and thus make a call when the second user is available.

FIG. 18 shows an example of the graphic user interface when the first user selects the mobile phone icon of the second user, shown in FIG. 14, while the mobile phone number of the second user is set to be not open to the public by the second user. FIG. 19 shows an example of the graphic user interface when the first user selects the mobile phone icon of the second user, shown in FIG. 14, while the mobile phone number of the second user is set to be open to the public by the second user.

Referring to FIG. 14, FIG. 18 and FIG. 19, when the first user selects the icon 1320 representing the mobile phone of “Jinny”, the second user, the mobile phone 110 displays a frame 1600 or 1700 making a call to the mobile phone 150 of “Jinny”. Unlike the frame 1600 shown in FIG. 18, the frame 1700 shown in FIG. 19 displays the mobile phone number of “Jinny”, the second user. “Jinny”, the second user, may decide whether the mobile phone number is to be open or not in the icon profile.

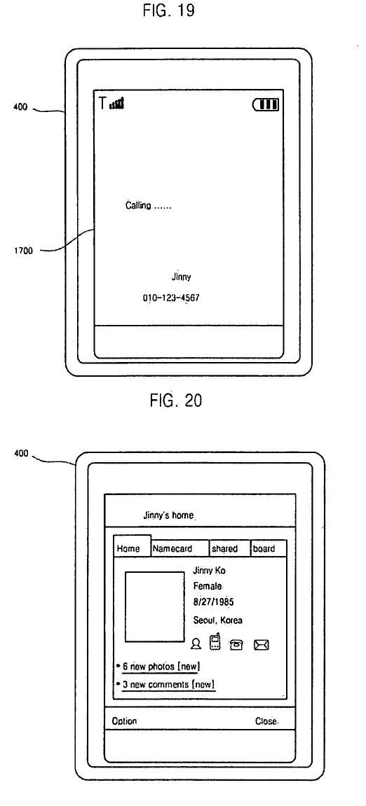

FIG. 20 to FIG. 23 show examples of the graphic user interface of a mini-homepage of the second user displayed in the communication terminal of the first user when the first user selects the mini-homepage icon of the second user shown in FIG. 14.

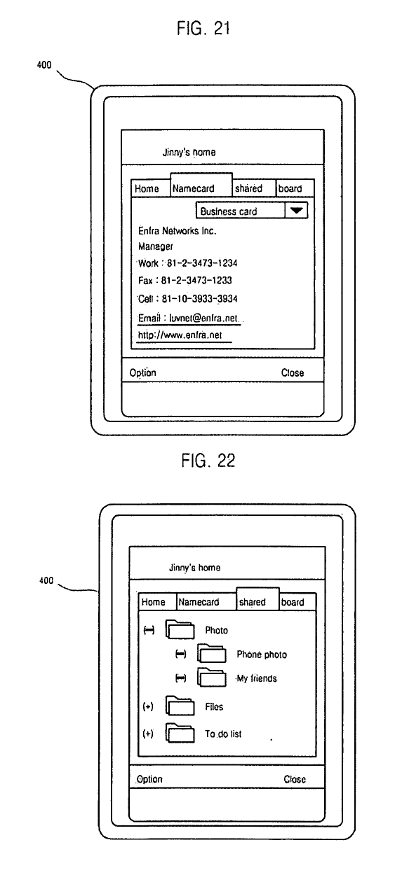

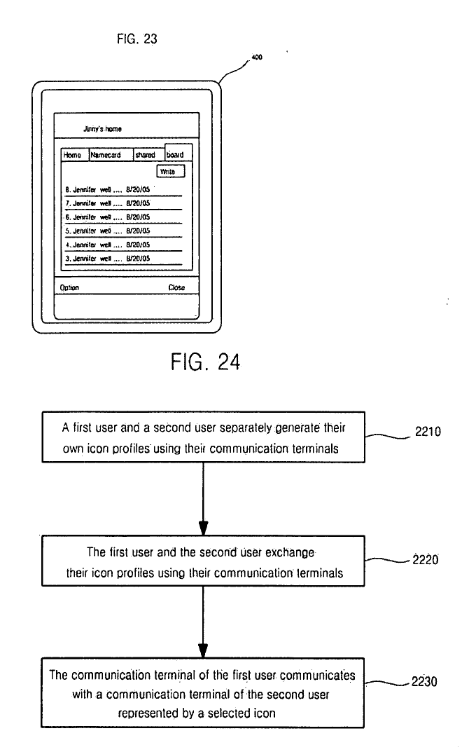

Referring to FIG. 14, FIG. 20, FIG. 21, FIG. 22 and FIG. 23, when the first user selects the icon 1340 representing a mini homepage address of “Jinny”, the second user, the mobile phone 110 is connected to the mini homepage of “Jinny”, the second user, through the wired/wireless communication network. Therefore, the first user can access information stored in the mini homepage of “Jinny”, the second user, using the mobile phone 110.

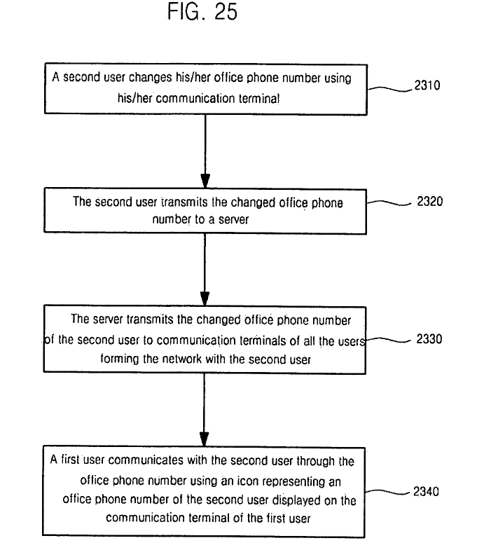

FIG. 24 is a flow chart showing the method for communication between the first user and the second user using icons according to an embodiment of the present invention. Referring to FIG. 1 to FIG. 8, FIG. 24, the first user and second user separately create at least one their own icon profile using their communication terminals 110 and 150 or PCs (2210). The first user and the second user exchange their icon profiles with each other using their communication terminals (2220).

The first user communicates (voice communication, data communication, etc.) with the communication terminals 150, 160, 170 and 180 of the second user represented by icons using the icons displayed in the communication terminal 110. Also, the second user communicates (voice communication, data communication, etc.) with the communication terminal 110 of the first user represented by an icon using the icon displayed in the communication terminal 150 (2230).

FIG. 25 is a flow chart showing the method for synchronizing an corrected office phone number of the second user with communication terminals of individuals forming the network with the second user according to an embodiment of the present invention. Referring to FIG. 1 to FIG. 23 and FIG. 25, the second user corrects his/her office phone number using his/her communication terminal (for example, mobile phone or PC) 150 (2310). The communication terminal 150 transmits the corrected office phone number to the server 130 (2320).

The server 130 transmits the corrected office phone number of the second user to the communication terminals (for example, mobile phones) of the users forming the network with the second user (2330). Thus, the updated office phone number of the second user is synchronized with the office phone number of the second user stored in the communication terminals of the users forming the network with the second user.

The first user communicates with the office phone of the second user using the icon representing an office phone number 1330 displayed in the mobile phone 110 (2340). Thus, the icon representing an office phone number 1330 represents the updated office phone number even when the second user changes works or positions and the office phone number is changed.

The embodiments of the present invention as described above can be made into programs which can be executed in a computer. Also, the programs read from a computer-readable medium recording the programs can be executed by a digital computer system. The computer-readable medium covers a storage medium such as a magnetic storage medium (for example, ROM, a floppy disk or a hard disk), an optical readable medium (for example, CD-ROM or DVD) and carrier wave (for example, transmission through the Internet).

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

### INDUSTRIAL APPLICABILITY

As described above, the present invention can be applied in mobile communication apparatuses or chips used in mobile communication apparatuses.

1. A communication terminal comprising:
an icon profile storage unit for storing at least one icon profile of a user of the communication terminal;
a selection unit for selecting a desired icon profile among the at least one icon profile stored in the icon profile storage unit;
a transmission unit for transmitting the icon profile selected by the selection unit to the outside of the communication terminal;
a receiving unit for receiving an icon profile of a second user output from a communication terminal of the second user; and
a received icon profile storage unit for storing the icon profile of the second user received by the receiving unit,
wherein the at least one icon profile of the user of the communication terminal includes icon for representing information of at least one communication terminal by the first user and the icon profile of the second user includes icon for representing information of the communication terminal used by the second user.

2. The communication terminal of claim 1, further comprising:
an icon storage unit for storing information of at least one icon; and
an icon profile generating unit for generating an icon profile of the user of the communication terminal based on the information of the at least one icon stored in the icon storage unit.

3. The communication terminal of claim 1, further comprising:
a connector for transmitting the at least one icon profile of the user of the communication terminal input from the outside of the communication terminal to the icon profile storage unit.

4. The communication terminal of claim 1, further comprising:
a connector for transmitting the at least one icon profile of the user of the communication terminal input from the outside of the communication terminal to the icon profile storage unit or information of the at least one icon input from the outside of the communication terminal to the icon storage unit.

5. The communication terminal of claim 1, further comprising:
an icon profile list for displaying the icon profiles of at least one second user stored in the received icon profile storage unit in a list; and
a connection unit for forming a communication cannel to perform communication between the communication terminal and a communication terminal of the second user represented by the selected icon when an icon is selected from the icon profile of the second user selected from the icon profile list.

6. The communication terminal of claim 1, wherein the transmission unit transmits an icon profile of the user of the communication terminal selected by the selection unit in response to a profile transmission signal output from the receiving unit to the outside of the communication terminal.

7. The communication terminal of claim 1, wherein the icon profile of the second user includes information of the second user and information of consanguinity degree between the user of the communication terminal and the second user.

8. The communication terminal of claim 1, wherein the first communication terminal and the second communication terminal each include mobile phones using CDMA, mobile phones using GSM, mobile phones using TDMA, phones using public switched telephone network (PSTN), phones using internet service provider (ISP) or PC.

9. A method for communication using an icon comprising:
icon profile generating, in which a first user and a second user separately generate their own icon profiles using their own communication terminals;
icon profile exchanging, in which the first user and the second user exchange their icon profiles selected by using their own communication terminals; and
communication channel forming, in which when the first user selects a first icon from at least one icon forming the icon profile of the second user displayed on the communication terminal of the first user, the communication terminal of the first user forms a communication channel to perform communication with the communication terminal of the second user represented by the selected first icon,
wherein the icon profile of the first user and the icon profile of the second user each include icons for representing information of at least one communication terminal used by the first user and the second user.

10. The method of claim 9, wherein the information of the communication terminal includes information of whether the communication terminal is in the communicable state.

11. A method for communication using an icon comprising:
first icon profile selecting, in which a first user selects a first icon profile from at least one icon profile of the first user stored in an icon profile storage unit using a first communication terminal of the first user;
transmitting, in which the first communication terminal transmits the selected first icon profile to a communication terminal of a second user; and
receiving and storing, in which the first communication terminal receives and stores an icon profile of the second user output from the communication terminal of the second user in response to the first user icon profile,
wherein the at least one first user icon profile includes icons for representing information of at least one communication terminal used by the first user and the icon profile of the second user includes icons for representing information of the communication terminal used by the second user.

12. The method of claim 11, further comprising:
communication channel forming, in which when the first user selects a first icon from at least one icon forming the icon profile of the second user displayed on the first communication terminal, the first communication terminal forms a communication channel to perform communication with a communication terminal of the second user represented by the selected first icon.

13. The method of claim 11, further comprising:
changed information receiving, in which when the second user changes information of a communication terminal of the second user represented by a first icon selected from at least one icon forming the at least one icon profile of the second user displayed on the first communication terminal using a communication terminal of the second user, the first communication terminal receives the changed information of a communication terminal of the second user input from the communication terminal of the second user; and
communication channel forming, in which when the first user selects the first icon displayed on the first communication terminal, the first communication terminal forms a communication channel to perform communication with the changed communication terminal of the second user represented by the selected first icon.

14. A method for displaying information of consanguinity degree using a communication terminal comprising:
first icon selecting, in which a first user selects a first icon representing information of consanguinity degree from an icon profile of a second user displayed on a first communication terminal of the first user;
information reading, in which the first communication terminal reads information of at least one third user forming a social network with the second user from a server; and
displaying, in which the first communication terminal displays an icon profile of the at least one third user on the first communication terminal, based on the information of the at least one third user read from the server,
wherein the icon profile of the second user includes the first icon representing the name of the second user and the degree of consanguinity between the first user and the second user.

15. The method of claim 14, wherein the icon profile of the third user includes a
second icon representing the name of the third user and the information of consanguinity degree between the first user and the third user.

16. The method of claim 14, wherein the icon profile of the third user includes a second icon representing the name of the third user and the degree of consanguinity between the second user and the third user.

17. A method for confirming a degree of consanguinity using a communication terminal comprising:
second user selecting, in which a first user selects a second user who is displayed in a call list of a communication terminal of the first user and has made a call to the communication terminal;
transmitting, in which the communication terminal transmits information of the selected second user to a server storing information of at least one individual forming the social network with the first user; and
displaying, in which the communication terminal displays information of consanguinity degree between the first user and the second user or information of consanguinity degree between at least one individual forming the social network with the first user and the second user on the communication terminal, based on information of consanguinity degree output from the server.

18. A method for confirming a degree of consanguinity using a communication terminal comprising:
transmitting, in which a first user selects a second user who is displayed in a call list of a communication terminal of the first user and has made a call to the communication, terminal;
transmitting, in which a first user transmits information of a second user who is a call correspondent to a server storing information of individuals forming a social network with the first user using a first communication terminal of the first user; and;
displaying, in which the first communication terminal displays information of consanguinity degree between the first user and the second user or information of consanguinity degree between at least one individual forming the social network with the first user and the second user, based on information of consanguinity degree output from the server.

19. (canceled)

20. (canceled)

21. (canceled)
